(19) United States
(12) Patent Application Publication
(10) Pub. No.: US 2008/0156155 A1
(43) Pub. Date: Jul. 3, 2008

(54) Punch and Die for Punching Out Laminates

(76) Inventors: Koen Van den Heuvel, Herselt (BE); Wim Hauchecorne, Puurs (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/872,992

(22) Filed: Oct. 16, 2007

Related U.S. Application Data
(60) Provisional application No. 60/863,257, filed on Oct. 27, 2006.

(30) Foreign Application Priority Data
Oct. 24, 2006 (EP) 06122801.1

(51) Int. Cl. B26F 1/44; B26D 1/00

(52) U.S. Cl. 83/13; 83/684

(57) ABSTRACT

A rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in the punch in respect of the first and second edges, wherein the object is substantially flat and has substantially uniform thickness and the first parallel pair of edges and the second parallel pair of edges delineate the shape of said punched out object; a rectangular, square or rhomboid-shaped die having four sides with dimensions substantially identical to those projected by the first, second, third and fourth edges of the above-disclosed rectangular, square or rhomboid-shaped punch on the first plane thereof; and use of the above-disclosed rectangular, square or rhomboid-shaped punch in co-operation with the above-disclosed rectangular, square or rhomboid-shaped die for punching out laminated cards.

### CROSS-REFERENCE TO RELATED PATENT APPLICATIONS

This application claims the benefit of U.S. Provisional Application No. 60/863,257 filed Oct. 27, 2006, which is incorporated by reference. In addition, this application claims the benefit of European Application No. 06122801.4 filed Oct. 24, 2006, which is also incorporated by reference.

### FIELD OF THE INVENTION

The invention relates to a punch and die used to punch out identification and financial documents, e.g. documents having data-bearing and/or financial functions including plastic cards such as financial (e.g. credit and debit) cards, driving licenses, national identification cards, and other similar cards, and a process using the punch and die to punch out identification documents.

### BACKGROUND OF THE INVENTION

DE 9315393U1 discloses a hole punching apparatus for rectangularly shaped holes with a rectangularly shaped punch, having a continuous/uninterrupted opening for accommodating an actuating shank, with whose help the punch is moved through the punching material in which the inner contours of the die correspond to the outside contours of the punch, whereby the punch presents edge surfaces, whose outermost edges are punch edges, characterized in that the punch edges (4) on the corner points (6) of the punch (1) viewed in the operating direction jut out furthest and each continuously further recedes in the direction of the middle of the side of the rectangle (beveled edges) and that at the edge surfaces (10) in the middle of a diametrically opposing pair of sides at right angles to the receding pair of sides, form cutting edges (8) up to the opening (2) in the punch (1) and up to the edge of the punch (1). DE 9315393U1 further discloses that “through the two cutting edges, which reach to the vicinity of the shank, the piece punched out is cut into two halves, which can be easily separated from one another, without the connection between the punch and the shank being loosened”.

The use of laminated identification and financial documents, such as financial (e.g. credit and debit) cards, drivers' licenses, national identification cards, and other like cards, as well as passports and the like, is well known. The documents are typically provided with one or more of printed characters and/or images, holographic images, embossed characters, laser-produced information, and data storage media such as an integrated circuit chip.

The laminated identification and financial documents are produced by known methods predominantly in a sheet form. For financial reasons one uses sheets which are as large as possible and divided into a plurality of individual document-sized copies. The arrangement of the copies is preferably identical on all sheets. The sheets of paper and plastic required for the subsequent document compound are prepared separately and superimposed in exact register prior to the lamination process. If possible, this process is performed automatically using sheet feeders or similar machines. The layers of paper and/or plastic are bonded together in a usual laminating press by the action of pressure and heat. The individual documents are thereafter punched out of the sheet material.

Alternatively individualized laminated identification and financial documents are produced in individualized sheet form and the individualized laminated identification and financial document is thereafter punched out of the individualized sheet.

This punching process must moreover be performed without adversely affecting the laminate being punched e.g. must not lead to deformation or edge delamination.

During the punching process a laminated identification and financial document is pushed under pressure by the punch into the die, whereupon the laminated identification and financial document is cut from the sheet. On a microscopic scale this is a tearing action. This process is one of a sequence of processes involved in the production of laminated identification and financial documents and in an automated production process its speed will be determined by the speed of the production line as a whole.

Rapid punching will require that the necessary force be applied within the time allowed. The higher the force required, the higher will be the cost of the punch/die unit. Moreover, the higher the force required the more likely it is that the laminate as such will be adversely affected by the punching process e.g. edge delamination due to bending of the card can occur.

Many commercially available punch and die devices for punching out laminated identification and financial documents use a punch in which the contacting surface is a diamond-shaped area in the same plane joining the centre points of each of the four sides of the punch, with the areas outside the diamond being cut away from the sides of the diamond to the corners of the punch with the corners being up to 1 mm from the plane of the diamond-shaped area. Such punches were developed for PVC-cards, but are not suitable for heterogeneous laminates such as those consisting of polyethylene/polyethylene terephthalate/PETG due to relaxation between the hard and soft lamella in the laminate due to the deformation of the card during the cutting process.

There is therefore a need for a punch and die device, which is suitable for cutting heterogeneous laminates without adversely affecting the laminate.

### ASPECTS OF THE INVENTION

It is an aspect of the present invention to provide a punch and die device, which is suitable for cutting heterogeneous laminates from of a heterogeneous laminate sheet without adversely affecting the laminate.

Further aspects of the invention will become apparent from the description hereinafter.

### SUMMARY OF THE INVENTION

Surprisingly it was found that heterogeneous laminates can be punched out with low tolerances from a heterogeneous sheet using a rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane as said first and second edges. Instead of cutting the punched-out material in two halves as disclosed in DE 9315393U1, the at least one further edge extending along the whole width or length of the punch surprisingly serves to pin the piece of laminate being cut out during the punching process thereby realizing acceptable dimensional tolerances in the piece of laminate thereby cut-out. The purpose of the present invention is to use the punch and die to punch out laminate cards and not to provide a hole in a material as is the case in the invention disclosed in DE 9315393U1.

Aspects of the present invention have been realized by a rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in the punch in respect of the first and second edges, wherein the object is substantially flat and has substantially uniform thickness and the first parallel pair of edges and the second parallel pair of edges delineate the shape of said punched out object.

Aspects of the present invention have also been realized by a rectangular, square or rhomboid-shaped die having four sides with dimensions substantially identical to those projected by the first, second, third and fourth edges of the above-disclosed rectangular, square or rhomboid-shaped punch on the first plane thereof for use in co-operation with said rectangular, square or rhomboid-shaped punch.

Aspects of the present invention have also been realized by the use of the above-described rectangular, square or rhomboid-shaped punch in co-operation with the above-described rectangular, square or rhomboid-shaped die for punching out laminated cards.

Further advantages and embodiments of the present invention will become apparent from the following description.

### BRIEF DESCRIPTION OF THE DRAWINGS

FIG. 1 is a schematic drawing of the bottom of the punch, according to the present invention, having a first edge, 1; a second edge, 2; a third edge, 3; a fourth edge 4; and a fifth edge, 5.

FIG. 2 is a schematic drawing of the profile of the third edge of the punch, 3, according to the present invention, together with the angles α, β, γ and δ.

### DETAILED DESCRIPTION OF THE INVENTION

### Definitions

The term “identification document” or “ID document”, as used in disclosing the present invention means a document bearing identifying data about the product or the individual whose name appears thereon. ID documents include credit cards, bank cards, phone cards, passports, driving licences, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards and badges. The terms “document,” “card,” “badge” and “documentation” are used interchangeably throughout this patent application.

The term “substantially sharp”, as used in disclosing the present invention, encompasses angular edges and rounded edges resulting from wear during use.

The term “substantially parallel to”, as used in disclosing the present invention, means at an angle of no more than 30° to, with no more than 25° to being preferred and no more than 20° to being particularly preferred.

The term “edge”, as used in disclosing the present invention, means a straight-edged pointed projection capable of contacting the heterogeneous laminate and at its ends providing a cutting function.

### Rectangular, Square or Rhomboid-Shaped Punch

Aspects of the present invention have been realized by a rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in the punch in respect of the first and second edges, wherein the object is substantially flat and has substantially uniform thickness and the first parallel pair of edges and the second parallel pair of edges delineate the shape of said punched out object.

According to a first embodiment of the rectangular, square or rhomboid-shaped punch, according to the present invention, wherein said third and fourth edges provide the end profiles of a construction consisting of a second plane, a third plane, a fourth plane and a fifth plane: said second plane forming an angle α with respect to said first plane and being between said first edge and a line perpendicular to said third edge from a first point on said third edge intermediate between said first edge and a line perpendicular to said first plane intersecting said third edge and equidistant from said first edge and said second edge, said third plane forming an angle β with respect to said first plane and being between said second edge and a line perpendicular to said third edge from a second point on said third edge intermediate between said second edge and said line perpendicular to said first plane, said fourth plane forming an angle γ with respect to said first plane and being between said line perpendicular to said third edge from said first point and a line perpendicular to said third edge from a third point on said line perpendicular to said first plane, and said fifth plane forming an angle δ with respect to said first plane and being between said line perpendicular to said third edge from said second point and said line perpendicular to said third edge from said third point, and wherein said first, second, third and fourth edges and the edges formed by said lines perpendicular to said third edge from said first, second and third points are substantially angular, said line perpendicular to said third edge from said third point is not in said first plane, α>γ and β>δ.

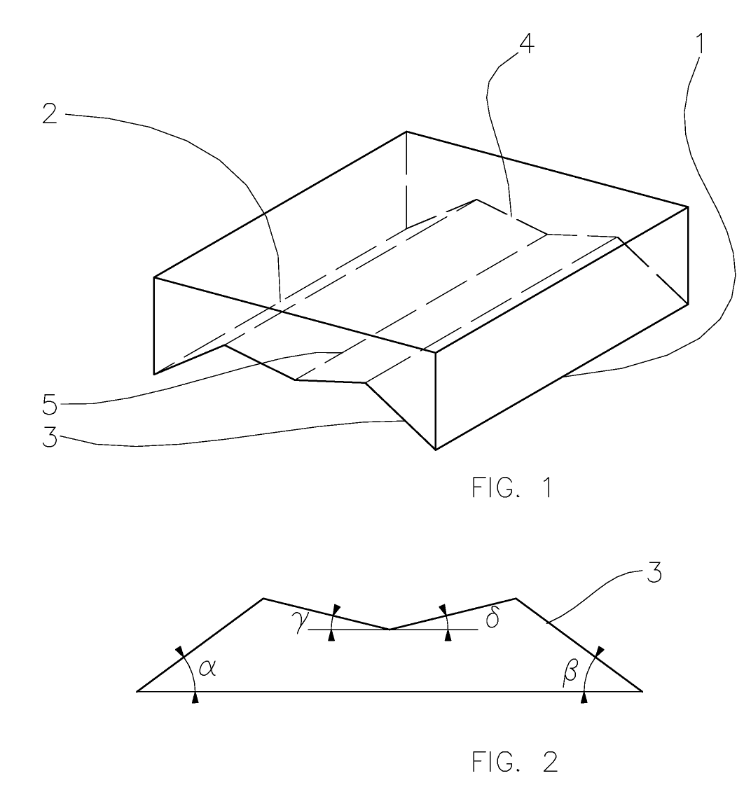

The shape of the bottom of the punch, according to one embodiment of the present invention, having a first edge, 1; a second edge, 2; a third edge, 3; a fourth edge 4; and a fifth edge, 5, is shown in FIG. 1 and the profile of one of the third edge of the punch, 3, according to one embodiment of the present invention, is shown in FIG. 2 together with the angles α, β, γ and δ.

According to a third embodiment of the rectangular, square or rhomboid-shaped punch, according to the present invention, the nearest distance in the plane of said third edge between said point 1 and 2 and said first plane is less than 80% of the thickness of said object being punched out.

According to a fourth embodiment of the rectangular, square or rhomboid-shaped punch, according to the present invention, α and β are both less than 5°, with less than 2° being preferred.

According to a fifth embodiment of the rectangular, square or rhomboid-shaped punch, according to the present invention, α=β.

According to a sixth embodiment of the rectangular, square or rhomboid-shaped punch, according to the present invention, γ=δ.

According to a seventh embodiment of the rectangular, square or rhomboid-shaped punch, according to the present invention, along the line intersecting said first and third surfaces the nearest points on said intersecting line from said points 1 and 2 are equidistant between the nearest point to said intersecting line from said point 3 and the intersections of said first and second edges with said intersecting line respectively.

Documents having data-bearing and/or financial functions are standardized for information technology, identification cards and financial transaction cards under ISO/IEC 7813. A format commonly used for banking cards and driving licences is the ID-1 format specifying a size of 85.60 mm by 53.98 mm with a thickness of 0.76 mm. The tolerances for the long-side dimension of information technology, identification cards and financial transaction cards are more stringent than those for the short-side dimensions due to the insertion of these cards in machines.

The use of punches with a flat bottom for the punching of heterogeneous sheets at a temperature of ca. 104° C. was found to give cards with straight sides with excellent quality, see Table 1.

TABLE 1

| | Card 1 | Card 2 | Card 3 | Card 4 |
|---|---|---|---|---|
| Length [mm] | 85.315 | 85.299 | 85.318 | 85.341 |
| | 85.255 | 85.27 | 85.269 | 85.279 |
| | 85.246 | 85.265 | 85.255 | 85.26 |
| | 85.263 | 85.299 | 85.259 | 85.258 |
| | 85.304 | 85.309 | 85.285 | 85.284 |
| largest deviation | 0.069 | 0.044 | 0.063 | 0.083 |
| [mm] | | | | |
| width [mm] | 53.746 | 53.744 | 53.755 | 53.795 |
| | 53.728 | 53.723 | 53.717 | 53.825 |
| | 53.736 | 53.727 | 53.715 | 53.809 |
| | 53.706 | 53.713 | 53.714 | 53.79 |
| | 53.729 | 53.722 | 53.723 | 53.81 |
| | 53.736 | 53.731 | 53.717 | 53.834 |
| | 53.736 | 53.762 | 53.752 | 53.851 |
| | 53.796 | 53.799 | 53.773 | 53.848 |
| | 53.83 | 53.822 | 53.808 | 53.88 |
| | 53.783 | 53.783 | 53.778 | 53.812 |
| largest deviation | 0 .124 | 0.109 | 0.094 | 0.09 |
| [mm] | | | | |

However, the forces required for punching were extremely high resulting in prohibitive wear on both the punch and the die used in co-operation with the punch, rendering this concept prohibitively expensive.

The use of commercial punch and die devices with a diamond-shaped bottom on heterogeneous laminate cards was found to need much less force than the punch with a flat bottom, but the cut edges were of a poor quality due to the cards being deformed prior to the cutting process occurring leading to the sides of the cards having a concave shape with rounded corners and edge-delamination being observed due to deformation despite the corners of the punch only being 1 mm from the plane of the diamond-shaped area. The long-side tolerances of the resulting cards were outside those laid down in ISO/IEC 1810:2003 (see results in Table 2) even for punching at room temperature.

TABLE 2

| | Card 5 | Card 6 | Card 7 |
|---|---|---|---|
| Length [mm] | 85.557 | 85.544 | 85.551 |
| | 85.603 | 85.598 | 85.608 |
| | 85.521 | 85.528 | 85.494 |
| | 85.608 | 85.602 | 85.615 |
| | 85.62 | 85.649 | 85.641 |
| largest deviation | 0.099 | 0.121 | 0.147 |
| [mm] | | | |
| width [mm] | 54.016 | 53.965 | 53.96 |
| | 54.085 | 53.969 | 53.996 |
| | 54.068 | 53.971 | 53.986 |
| | 54.013 | 53.951 | 53.968 |
| | 53.919 | 53.939 | 53.937 |
| | 53.946 | 53.949 | 53.932 |
| | 54.028 | 53.956 | 53.975 |
| | 54.081 | 53.964 | 54 |
| | 54.095 | 53.971 | 54.014 |
| | 54.04 | 53.965 | 54.031 |
| largest deviation | 0.176 | 0.032 | 0.099 |
| [mm] | | | |

A punch with long edges providing the first contact with and thereby pinning the object being punched out with the bottom being worked to form a V-shape was found to give long edges with very poor long-side tolerances and acceptable short-side tolerances with respect to those laid down in ISO/IEC 1810:2003 with a V-shape with a depth of 0.8 mm (see results in Table 3 for heterogeneous sheets at a temperature of 104° C.).

TABLE 3

| | Card 8 | Card 9 | Card 10 | Card 11 | Card 12 | Card 13 |
|---|---|---|---|---|---|---|
| Length [mm] | 85.429 | 85.385 | 85.41 | 85.393 | 85.385 | 85.425 |
| | 85.568 | 85.531 | 85.539 | 85.527 | 85.529 | 85.562 |
| | 85.631 | 85.579 | 85.604 | 85.589 | 85.613 | 85.612 |
| | 85.559 | 85.495 | 85.513 | 85.516 | 85.523 | 85.538 |
| | 85.383 | 85.358 | 85.355 | 85.345 | 85.354 | 85.371 |
| largest | 0.248 | 0.221 | 0.249 | 0.244 | 0.259 | 0.241 |
| deviation | | | | | | |
| [mm] | | | | | | |
| width [mm] | 53.719 | 53.71 | 53.719 | 53.715 | 53.706 | 53.724 |
| | 53.726 | 53.733 | 53.74 | 53.733 | 53.72 | 53.721 |
| | 53.73 | 53.709 | 53.714 | 53.71 | 53.768 | 53.726 |
| | 53.741 | 53.722 | 53.717 | 53.715 | 53.717 | 53.744 |
| | 53.752 | 53.802 | 53.735 | 53.734 | 53.773 | 53.771 |
| | 53.73 | 53.729 | 53.732 | 53.729 | 53.729 | 53.762 |
| | 53.736 | 53.738 | 53.745 | 53.734 | 53.745 | 53.732 |
| | 53.735 | 53.765 | 53.756 | 53.73 | 53.742 | 53.743 |
| | 53.739 | 53.724 | 53.757 | 53.72 | 53.733 | 53.745 |
| | 53.744 | 53.723 | 53.718 | 53.713 | 53.726 | 53.752 |
| largest | 0.033 | 0.093 | 0.043 | 0.024 | 0.067 | 0.05 |
| deviation | | | | | | |
| [mm] | | | | | | |

With a punch with a V-shape with a depth of 0.4 mm the long-side tolerances decreased but the short-side tolerances deteriorated (see results in Table 4 for heterogeneous sheets at a temperature of 104° C.).

TABLE 4

| | Card 14 | Card 15 | Card 16 | Card 17 |
|---|---|---|---|---|
| Length [mm] | 85.534 | 85.499 | 85.477 | 85.488 |
| | 85.635 | 85.595 | 85.555 | 85.578 |
| | 85.615 | 85.584 | 85.539 | 85,557 |
| | 85.606 | 85.564 | 85.524 | 85.55 |
| | 85.437 | 85.414 | 85.434 | 85.413 |
| largest deviation | 0.198 | 0.181 | 0.121 | 0.165 |
| [mm] | | | | |
| width [mm] | 53.88 | 53.844 | 53.814 | 53.834 |
| | 53.831 | 53.823 | 53.793 | 53.811 |
| | 53.838 | 53.815 | 53.781 | 53.811 |
| | 53.836 | 53.805 | 53.787 | 53.805 |
| | 53.847 | 53.824 | 53.796 | 53.82 |
| | 53.847 | 53.827 | 53.807 | 53.812 |
| | 53.917 | 53.887 | 53.862 | 53.872 |
| | 53.937 | 53.896 | 53.881 | 53.89 |
| | 53.95 | 53.902 | 53.878 | 53.889 |
| | 53.882 | 53.859 | 53.836 | 53.843 |
| largest deviation | 0.119 | 0.097 | 0.1 | 0.085 |
| [mm] | | | | |

The best compromise between the low long-side tolerances achieved with a flat-bottomed punch and a punch with a diamond-shaped bottom giving edge-delamination due to deformation was a punch with the long sides providing the first contact with and thereby pinning the object being punched out with the bottom being worked so that a further edge was produced substantially parallel to and between the long sides, but recessed several tenths of mm's into the punch, see FIG. 1. The results in Table 5 are for an edge recessed 0.2 mm into the punch and with V-shapes either side with a depth of 0.4 mm and were realized with heterogeneous sheets at a temperature of ca. 104° C. This further edge surprisingly assisted the punching out of the long-sides of the card and produced an edge within the dimensional tolerances required by the ISO-norm for cards: 7813-1987 (see Table 5) for both the long and short sides and no edge delamination, apparently due to the force distribution being more favourable. Moreover, this punch required substantially less force than that required by the flat-bottomed punch and hence much reduced collateral wear of the punch and die.

TABLE 5

| | Card 18 | Card 19 | Card 20 | Card 21 | Card 22 | Card 23 | Card 24 | Card 25 |
|---|---|---|---|---|---|---|---|---|
| Length [mm] | 85.473 | 85.45 | 85.445 | 85.455 | 85.381 | 85.441 | 85.42 | 85.418 |
| | 85.53 | 85.52 | 85.509 | 85.524 | 85.438 | 85,552 | 85.515 | 85.51 |
| | 85.452 | 85.459 | 85.468 | 85.461 | 85.418 | 85.551 | 85.508 | 85.502 |
| | 85.525 | 85.521 | 85.519 | 85.522 | 85.444 | 85.546 | 85.525 | 85.509 |
| | 85.409 | 85.402 | 85.404 | 85.418 | 85.387 | 85.383 | 85.38 | 85.387 |
| largest deviation | 0.121 | 0.119 | 0.115 | 0.106 | 0.063 | 0.169 | 0.145 | 0.123 |
| [mm] | | | | | | | | |
| width [mm] | 53.78 | 53.769 | 53.757 | 53.77 | 53.759 | 53.788 | 53.794 | 53.776 |
| | 53.767 | 53.763 | 53.767 | 53.783 | 53.775 | 53.79 | 53.789 | 53.766 |
| | 53.78 | 53.767 | 53.761 | 53.781 | 53.76 | 53779 | 53.777 | 53.765 |
| | 53.77 | 53.766 | 53.765 | 53.781 | 53.745 | 53.764 | 53.77 | 53.756 |
| | 53.776 | 53.773 | 53.774 | 53.783 | 53.748 | 53.757 | 53.763 | 53.751 |
| | 53.757 | 53.762 | 53.763 | 53.775 | 53.751 | 53.752 | 53.755 | 53.745 |
| | 53.799 | 53.811 | 53.808 | 53.825 | 53.75 | 53.752 | 53.754 | 53.743 |
| | 53.787 | 53.799 | 53.807 | 53.826 | 53.744 | 53.748 | 53.745 | 53.741 |
| | 53.831 | 53.845 | 53.835 | 53.852 | 53.738 | 53.782 | 53.758 | 53.737 |
| | 53.829 | 53.804 | 53.811 | 53.821 | 53.731 | 53.767 | 53.744 | 53.753 |
| largest deviation | 0.074 | 0.083 | 0.078 | 0.082 | 0.044 | 0.042 | 0.05 | 0.039 |
| [mm] | | | | | | | | |

According to an eighth embodiment of the rectangular, square or rhomboid-shaped punch, according to the present invention, the fifth edge is recessed by 0.5 mm or less, with recession by 0.4 mm or less being preferred, recession by 0.3 mm or less being particularly preferred and recession by 0.2 mm or less being especially preferred.

According to a ninth embodiment of the rectangular, square or rhomboid-shaped punch, according to the present invention, the fifth edge is recessed by 0.05 mm or more.

The cutting forces required by the flat-bottomed and the punch concept, according to the present invention, were calculated to be 21,920N and 13,440N respectively, whereas the punch with the diamond-shaped bottom required a force of 3200N. The cutting torque with the punch concept, according to the present invention, is about 100 N/mm².

According to a tenth embodiment of the rectangular, square or rhomboid-shaped punch, according to the present invention, the at least one further edge is not a cutting edge.

### Rectangular, Square or Rhomboid-Shaped Die

Aspects of the present invention have also been realized by a rectangular, square or rhomboid-shaped die having four sides with dimensions substantially identical to those projected by the first, second, third and fourth edges of the above-disclosed rectangular, square or rhomboid-shaped punch on the first plane thereof for use in co-operation with the rectangular, square or rhomboid-shaped punch.

According to a first embodiment of the rectangular, square or rhomboid-shaped die, according to the present invention, the tolerance between the above-disclosed rectangular, square or rhomboid-shaped punch disclosed and said above-disclosed rectangular, square or rhomboid-shaped die is between 14 and 18 μm.

### Use of the Rectangular, Square or Rhomboid-Shaped Punch

Aspects of the present invention have also been realized by the use of the above-described rectangular, square or rhomboid-shaped punch in co-operation with the above-described rectangular, square or rhomboid-shaped die for punching out laminated cards.

According to a first embodiment of the use of the rectangular, square or rhomboid-shaped punch, according to the present invention, the documents comprise foils and layers of different materials.

According to a second embodiment of the use of the rectangular, square or rhomboid-shaped punch, according to the present invention, the laminated cards are documents having data-bearing and/or financial functions.

### Laminated Identification and Financial Documents

Laminated identification and financial documents comprise multiple lamellae, layers, bonding and subbing layers with human readable and/or covered (i.e. detectable but not human readable) security features on a support. The lamellae can be paper or polymeric, polymeric lamellae include polyvinyl chloride (PVC), acrylonitrile butadiene styrene (ABS), methacylonitrile butadiene styrene (MBS), polyethylene terephthalate (PET), glycol modified polyester (PETG), polypropylene (PP), polyethylene (PE) and polycarbonate (PC). Polymeric type supports include cellulose acetate propionate or cellulose acetate butyrate, polyesters such as polyethylene terephthalate and polyethylene naphthalate, polyvinylchloride, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. Polyester film supports and especially poly(ethylene terephthalate) and glycol modified poly(ethylene terephthalate) (=PETG) are preferred. When such a polyester is used as the support material, a subbing layer may be employed to improve the bonding of the ink-receiving layer to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in said punch in respect of said first and second edges, wherein said object is substantially flat and has substantially uniform thickness and said first parallel pair of edges and said second parallel pair of edges delineate the shape of said punched out object.

2. The rectangular, square or rhomboid-shaped punch according to claim 1, wherein said third and fourth edges provide the end profiles of a construction consisting of a second plane, a third plane, a fourth plane and a fifth plane:
said second plane forming an angle α with respect to said first plane and being between said first edge and a line perpendicular to said third edge from a first point on said third edge intermediate between said first edge and a line perpendicular to said first plane intersecting said third edge and equidistant from said first edge and said second edge,
said third plane forming an angle β with respect to said first plane and being between said second edge and a line perpendicular to said third edge from a second point on said third edge intermediate between said second edge and said line perpendicular to said first plane,
said fourth plane forming an angle γ with respect to said first plane and being between said line perpendicular to said third edge from said first point and a line perpendicular to said third edge from a third point on said line perpendicular to said first plane, and
said fifth plane forming an angle δ with respect to said first plane and being between said line perpendicular to said third edge from said second point and said line perpendicular to said third edge from said third point,
and wherein said first, second, third and fourth edges and the edges formed by said lines perpendicular to said third edge from said first, second and third points are substantially angular, said line perpendicular to said third edge from said third point is not in said first plane, α>γ and β>δ.

3. The rectangular, square or rhomboid-shaped punch according to claim 1, wherein the nearest distance in the plane of said third edge between said point 1 and 2 and said first plane is less than 80% of the thickness of said object being punched out.

4. The rectangular, square or rhomboid-shaped punch according to claim 2, wherein α and β are both less than 5°.

5. The rectangular, square or rhomboid-shaped punch according to claim 2, wherein α and β are both less than 2°.

6. The rectangular, square or rhomboid-shaped punch according to claim 2, wherein α=β.

7. The rectangular, square or rhomboid-shaped punch according to claim 2, wherein γ=δ.

8. The rectangular, square or rhomboid-shaped punch according to claim 1, wherein along the line intersecting said first and third surfaces the nearest points on said intersecting line from said points 1 and 2 are equidistant between the nearest point to said intersecting line from said point 3 and the intersections of said first and second edges with said intersecting line respectively.

9. A rectangular, square or rhomboid-shaped die having four sides with dimensions substantially identical to those projected by the first, second, third and fourth edges of a rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in said punch in respect of said first and second edges, wherein said object is substantially flat and has substantially uniform thickness and said first parallel pair of edges and said second parallel pair of edges delineate the shape of said punched out object on the first plane thereof for use in co-operation with said rectangular, square or rhomboid-shaped punch.

10. The rectangular, square or rhomboid-shaped die according to claim 9, wherein the tolerance between the rectangular, square or rhomboid-shaped punch disclosed in any one of claims 1 to 8 and said rectangular, square or rhomboid-shaped die is between 14 and 18 μm.

11. A process using a rectangular, square or rhomboid-shaped punch having at least five edges optionally with at least one of the four points at which two edges meet having a rounded edge at said point, said at least five edges consisting of a first parallel pair of edges having a first and second edge describing a first plane, said first parallel pair of edges being capable of first contacting an object being punched out therewith, a second parallel pair of edges having a third and a fourth edge, and at least one further edge parallel to said first plane and substantially parallel to and between said first and said second edges, but not in the same plane and recessed in said punch in respect of said first and second edges, wherein said object is substantially flat and has substantially uniform thickness and said first parallel pair of edges and said second parallel pair of edges delineate the shape of said punched out object; in co-operation with a rectangular, square or rhomboid-shaped die having four sides with dimensions substantially identical to those projected by the first, second, third and fourth edges of said rectangular, square or rhomboid-shaped punch for punching out laminated cards.

12. The process according to claim 11, wherein said laminated cards comprise foils and layers of different materials.

13. The process according to claim 11, wherein said laminated cards are documents having data-bearing and/or financial functions.
